(19) United States
(12) Patent Application Publication
(10) Pub. No.: US 2008/0313353 A1
(43) Pub. Date: Dec. 18, 2008

(54) Web Console With Xml/Xsl Interface

(75) Inventors: Chris Roediger, Dielheim (DE); Ben-Shaul Yair, Hadera (IL); Arkadi Kagan, Petach-Tikva (IL); Gideo Mair, Hadera (IL); Oleg Belilovsky, Ramat-Gan (IL); Sergey Tsigelman, Netanya (IL); Christoph Lessmoellmann, Bad Shoenborn (DE); Alexander Rosenbaum, Raanana (IL)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SAP AKTIENGESELLSCHAFT, Walldorf (DE)

(21) Appl. No.: 11/662,852

(22) PCT Filed: Aug. 24, 2004
(86) PCT No.: PCT/EP04/51892

§ 371 Date: Jul. 21, 2008

(51) Int. Cl. G06F 15/16

(52) U.S. Cl. 709/246

(57) ABSTRACT

The invention provides methods and apparatus, for interfacing communicating between a plurality of portable devices and a warehouse management system, each of the devices being equipped with a web browser for displaying visual content, the warehouse management system comprising for each of the devices an XSL file associated therewith, the XSL file comprising information for transforming XML data in a format which can be displayed on the web browser of the associated device, the method comprising: receiving, from the warehouse management system, a GUI screen comprising content to be displayed on the web browser of one selected device of the portable devices; generating XML data which describes GUI screen controls representing the content; transforming the XML data by use of the XSL file which is associated with the selected device; and transmitting the transformed file to the device for display by the device web browser.

This application relates to warehouse management in general and in particular to web consoles for portable devices used in warehouses.

In warehouse environment, workers often perform operations under warehouse management control with use of portable electronic devices. Such operations include scanning bar codes applied on goods in the warehouse, reading radio frequency (RF) tags, and communicating with other people inside or outside the warehouse. Hereto, a wide variety of devices exist for performing these activities, such as optical barcode scanning devices, RFID tag readers, and mobile or smart phones, PDAs, and laptops. All these devices have displays functioning as interface to the humans. Many different technical standards exist for transmitting and displaying graphical and/or textual content on a display. In order to make communication for display independent from the hardware of the devices, Web browser technology is known, which separates hardware from the display communication. One language of communication in the Web is the hyper text markup language (HTML), a more general approach is the extensible markup language (XML). However, due to the limited space and weight available to these devices, their processing capabilities as well as display performance is limited as well. Therefore, not every device is equally able to display the same content as others.

According to the first aspect of the invention, there is provided a method of interfacing communicating between a plurality of portable devices and a warehouse management system, each of the devices being equipped with a web browser for displaying visual content, the warehouse management system comprising for each of the devices an extensible style sheet language XSL file associated therewith, the XSL file comprising information for transforming XML data in a format which can be displayed on the web browser of the associated device, the method comprising:

receiving, from the warehouse management system, a GUI screen comprising content to be displayed on the web browser of one selected device of the portable devices;

generating XML data which describes GUI screen controls representing the content;

transforming the XML data by use of the XSL file which is associated with the selected device; and

transmitting the transformed file to the device for display by the device web browser.

According to a further aspect of the invention, there is provided a method of receiving data by a portable device from a web-enabled console application of a warehouse management system, the device being equipped with a web browser for displaying graphical and textual content, the web-enabled console application comprising a plurality of XSL files for a plurality of portable devices, each of the XSL files comprising information for transforming XML data in a format which can be displayed on the web browser of the device, the method comprising:

receiving data transmitted from web-enabled console application, the data being to be displayed by the web browser, the data being generated by a transformation of an XML file which describes GUI screen controls representing the content to be displayed, the transformation being performed by use of the XSL file which is associated with the selected portable device;

displaying the transformed file on the display of the selected portable device by the web browser.

The portable devices may include at least one of laptop, PDA, mobile phone, barcode scanner, RFID tag reader, and smartphone.

The transmission to the portable device may be performed on basis of an internet protocol.

In a further embodiment of the invention RFID tag information is read by a portable device and transmitted to the warehouse management system.

RFID tag information may be modified in an RFID tag upon an instruction transmitted by the web-enabled console application.

Information comprised in an RFID tag may comprise a uniform resource locator to a location where information associated with the RFID tag is stored.

In a further embodiment of the invention a plurality of communication protocols for communicating with portable devices is supported by the web-enabled console application.

Data may be mapped to data according to a selected one of the communication protocols by the web-enabled console application.

Yet further, bar code information may be scanned by the portable device and transmitted to the web-enabled console application.

Data to be displayed on the device is reduced to data without toolbar, or rulers.

According to an embodiment of the invention, the portable devices are coupled via a wide area network with the web-enabled console application.

In particular, the invention comprises also computer systems for performing the inventive methods.

Furthermore, the invention comprises computer-readable storage media comprising program code for performing the inventive methods, when loaded into a computer system.

Embodiments of the invention are further described in connection with the drawings, in which

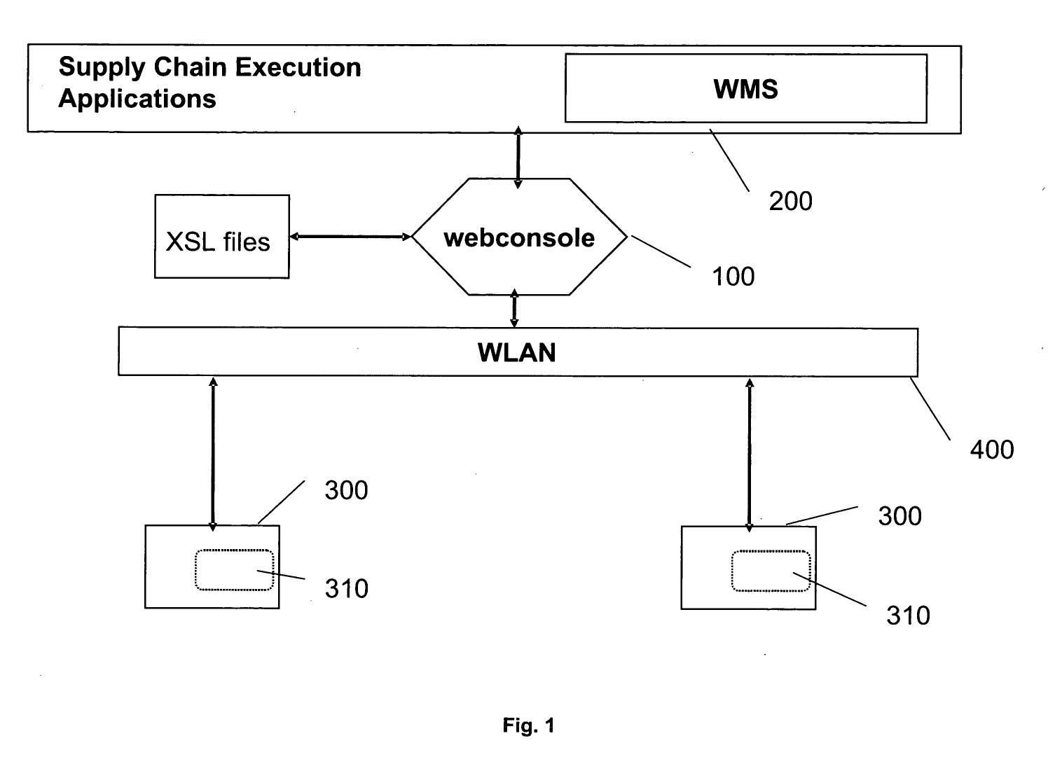

FIG. 1 illustrates an overview of the warehouse management application wherein the invention is used;

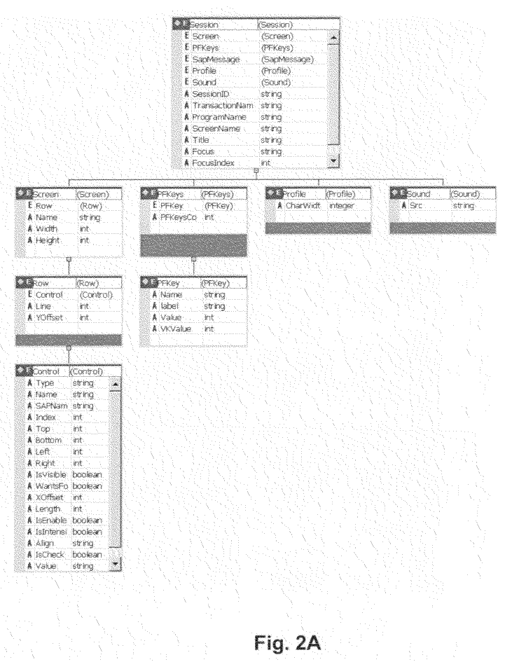

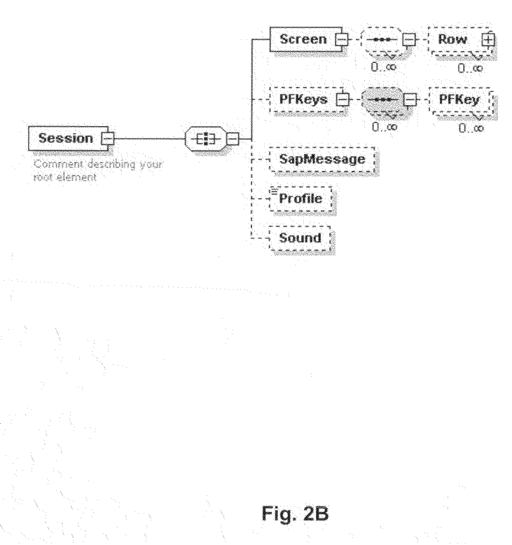

FIGS. 2A, B illustrate details of the XSL file according to the present invention; and

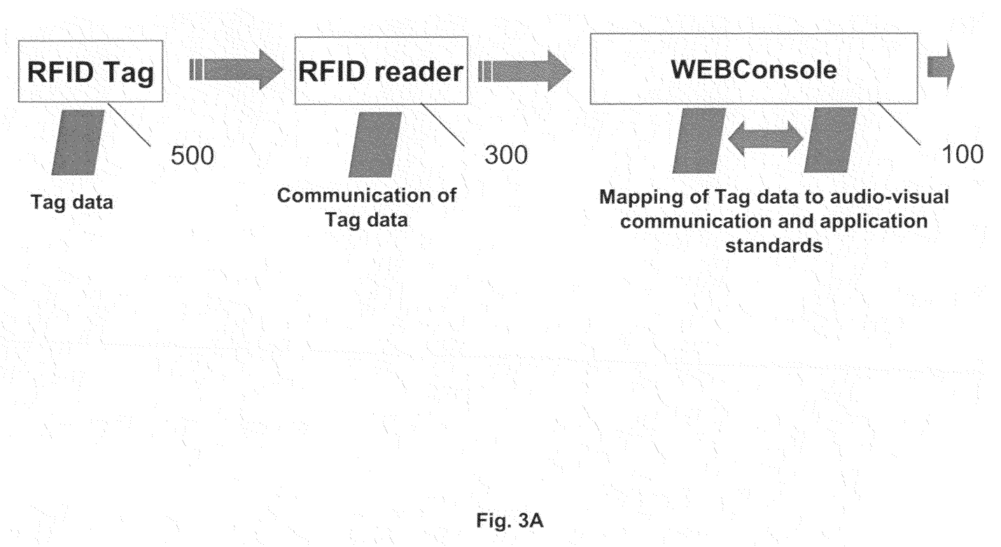

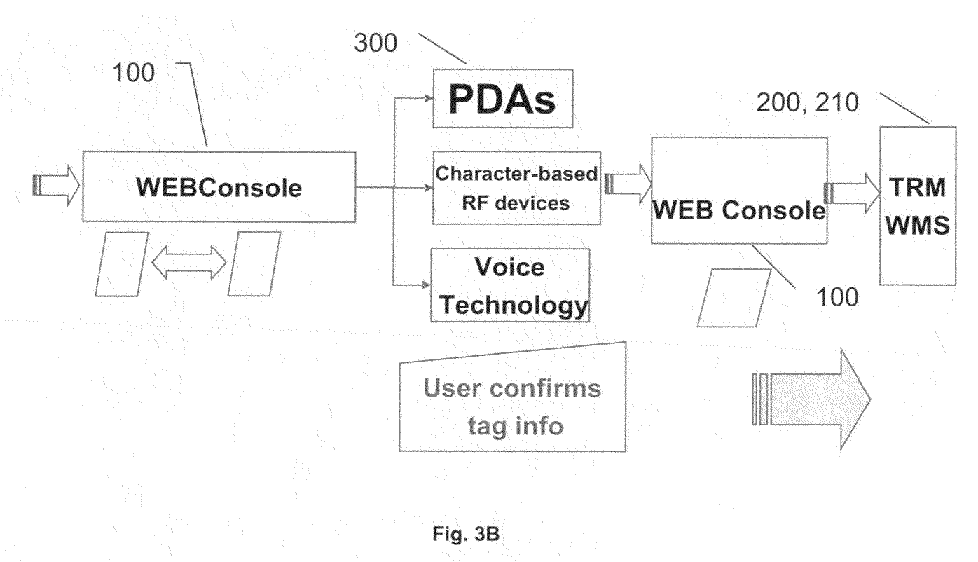

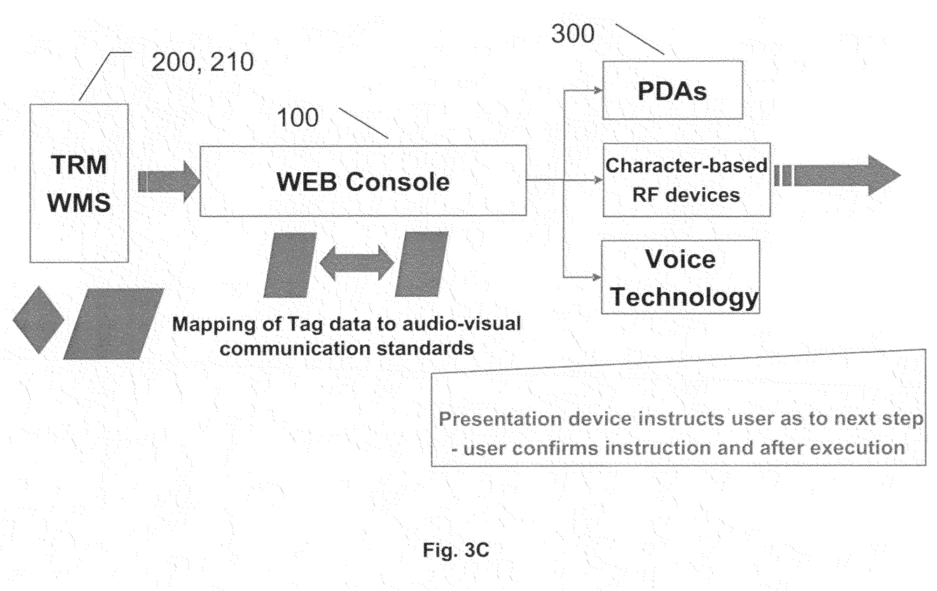

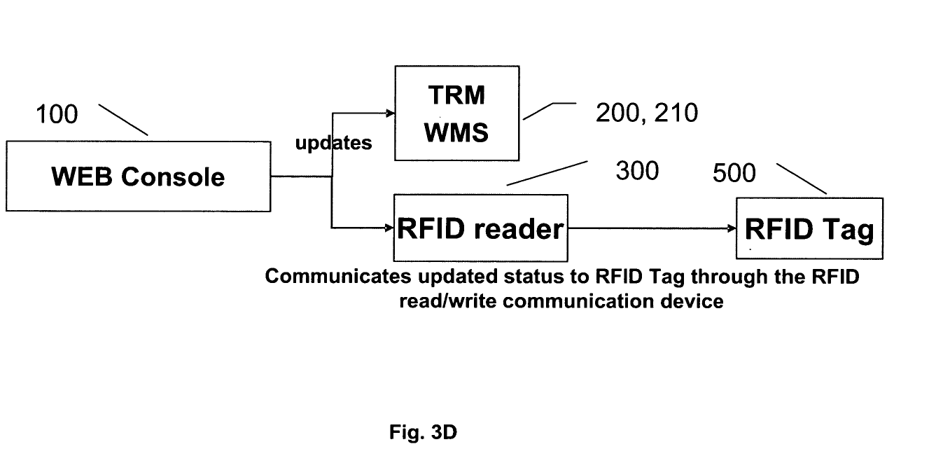

FIGS. 3A-D illustrate an example of the method according to FIGS. 1 and 2.

In FIG. 1, an overview of a representation of the communication facilities in a warehouse environment is given. It is demonstrated how a browser in a portable device that provides for display, communicates with a supply chain application such as a warehouse management system (WMS) using the web-enabled SAPconsole application 100. Web-enabled SAPconsole application is a product delivered by SAP Aktiengesellschaft, Walldorf, Germany.

The web-enabled SAPconsole application 100 is located logically between a warehouse management system 200 and a number of portable devices 300, from which only two are shown. Portable devices 300 may be PDAs, barcode scanners, or RFID tag readers. Connection between the web-enabled SAPconsole application 100 and the portable devices 300 is provided by a kind of wide area network 400.

Portable device 300 is equipped, in this example, with a web browser component 310.

Typically, a screen to be displayed in a browser window consists of inner content and frames such as toolbars, and rulers. Since not every display device has the full capability of displaying graphical content, the possibility is provided to display the content of the inner screen only whereby non relevant data such as toolbar/rulers is eliminated.

The Web-enabled SAPConsole according to this invention supports also RF devices that are based on WinCE/PocketPC operating system.

Thus, there is one single displayer with an XML interface that can use different XSL files, allowing different RF devices with various operating systems using different browsers to connect to the warehouse management system.

The web-enabled SAPconsole application 100 receives from the warehouse management system a graphic user interface (GUI) screen and creates XML data that describes the screen controls. This data is then processed by an XSL-transformer to create data that can be executed on the mobile device browser.

The XSL-transformer uses an XSL file together with the XML data to create the final HTML-stream that is sent to the device browser. The XSL file is unique for each type of device/browser.

The steps for creating the XSL file for the XML supplied by the web-enabled SAPconsole application 100 are as follows:

Details of the XML schema, and a sample XSL are shown in FIGS. 2A, B. FIG. 2A shows a table view of the XML schema. In the XML tree, “E” is an element, whereas “A” denotes an attribute. FIG. 2B gives the schema of the XML stream generated from a screen data.

One of the advantages is the capability of the web-enabled SAPconsole application 100 to process with XML interface using an XSL file. A standard interface is provided to which any RF device can connect with his proprietary browser by using the XSL translation file associated therewith.

Taking reference to FIG. 3A to 3D, the function of the embodiment is described for a scenario which comprises updating an RFID smart tag 500 with new status and info data by use of a portable RFID tag reader.

The RFID tag reader 300 reads an RFID smart tag 500, which is applied on an item in the warehouse, see FIG. 3A. The RFID tag reader 300 then transmits, via WLAN 400, the read information to the web-enabled SAPconsole application 100, which supports several standards of communication protocols/bandwidths and RFID smart tags 500 of different manufacturer. The web-enabled SAPconsole application 100 maps the received data to data according to different audio/visual communication and application standards, in order to enable different audio-visual devices to display the RFID smart tag information content for confirmation by the user and in order to format the tag information for different applications.

Then, the smart tag information is transmitted to a handheld device 300 or passed to a voice recognition system enabling the user to confirm the identification, see FIG. 3B. Upon confirmation the information is passed, via web-enabled SAPconsole application 100 to the application such as TRM, which will then check the next required execution step (task) to be performed on this item.

The next task is then given from TRM to the web-enabled SAPconsole application 100 for audio-visual presentation to the user with an instruction as how to proceed, see FIG. 3C.

Upon execution confirmation, the smart tag 500 is updated as to its new status, see FIG. 3D.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks, and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide interaction with a user, the invention can be implemented on a computer system having a display device such as a monitor or LCD screen for displaying information to the user and a keyboard and a pointing device such as a mouse or a trackball which the user can use with the computer system. The computer system can be programmed to provide a graphical or text user interface through which computer programs interact with users.

A computer may include a processor, a memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

Other embodiments are in the scope of the following claims.

1. A method of communicating between a plurality of portable devices and a warehouse management system, each of the devices being equipped with a web browser to display visual content, the method comprising:
maintaining an extensible style sheet language (XSL) file for each of the devices, the XSL file comprising information to transform extensible markup language (XML) data in a format which can be displayed on the web browser of the corresponding device;
receiving, from the warehouse management system, a graphical user interface (GUI) screen comprising content to be displayed on the web browser of one selected device of the portable devices;
generating XML data which describes GUI screen controls representing the content;
transforming the XML data by use of the XSL file which is associated with the selected device; and
transmitting the transformed file to the device for display by the device web browser.

2. The method of claim 1, wherein the portable devices include at least one of laptop, personal digital assistant (PDA), mobile phone, barcode scanner, radio frequency identification (RFID) tag reader, and smartphone.

3. The method of claim 1, wherein transmitting comprises:
employing an internet protocol.

4. The method of claim 1, wherein radio frequency identification (RFID) tag information is read by a portable device and transmitted to the warehouse management system.

5. The method of claim 1 further comprises:
supporting a plurality of communication protocols to communicate with portable devices.

6. The method of claim 1 further comprises:
scanning bar code information with the portable device; and
transmitting the bar code information to the web-enabled console application.

7. The method of claim 4, wherein information comprised in a radio frequency identification (RFID) tag comprises a uniform resource locator to a location where information associated with the RFID tag is stored.

8. The method of claim 5 further comprises:
mapping data according to a selected one of the communication protocols.

9. A method of communicating data between a portable device and a web-enabled console application of a warehouse management system, the device having a web browser to display graphical and textural content, the web-enabled console application having a plurality of extensible style sheet language (XSL) files for a plurality of portable devices, each of the XSL files comprising information to transform extensible markup language (XML) data in a format which can be displayed on the web browser of the portable device, the method comprising:
receiving data transmitted from web-enabled console application, the data being to be displayed by the web browser, the data being generated by a transformation of an XML file which describes graphical user interface (GUI) screen controls representing the content to be displayed, the transformation being performed using the XSL file which is associated with the selected portable device; and
displaying the transformed file on the display of the selected portable device by the web browser.

10. The method of claim 8, wherein radio frequency identification (RFID) tag information is modified in an RFID tag upon an instruction transmitted by the web-enabled console application.

11. The method of claim 8 wherein displaying comprises:
limiting the displayed data to data without toolbar, or rulers.

12. The method of claim 8, wherein the portable device is coupled via a wide area network with the web-enabled console application.

13. A system comprising:
a first portable device with a first browser requirement;
a second portable device with a second different browser requirement;
a warehouse management system; and
an interface between the warehouse management system and the plurality of portable devices to issue that data sent by the warehouse management system satisfies the browser requirement of each target portable device.
